(19) United States
(12) Patent Application Publication
(10) Pub. No.: US 2025/0334893 A1
(43) Pub. Date: Oct. 30, 2025

(54) RESIN PARTICLE, TONER, AND IMAGE FORMING APPARATUS

(71) Applicants: Yuka MIZOGUCHI, Kanagawa (JP); Akio TAKEI, Kanagawa (JP); Suzuka KARATO, Kanagawa (JP); Junichi WATANABE, Kanagawa (JP)

(72) Inventors: Yuka MIZOGUCHI, Kanagawa (JP); Akio TAKEI, Kanagawa (JP); Suzuka KARATO, Kanagawa (JP); Junichi WATANABE, Kanagawa (JP)

(21) Appl. No.: 19/186,626

(22) Filed: Apr. 23, 2025

(30) Foreign Application Priority Data
Apr. 26, 2024 (JP) 2024-072853

(51) Int. Cl. G03G 9/087; G03G 15/10

(52) U.S. Cl. CPC G03G 9/08755; G03G 15/10

(57) ABSTRACT

A resin particle is provided that includes a binder resin comprising a polyester resin. The resin particle has a volume average particle diameter of 4.5 μm or more and 6.0 μm or less, the resin particle has an adhesive strength of 150 gf or less, and the resin particle satisfies the following relational expressions (1) to (3):

$$0.93 \leq X \leq 0 \text{.980} \qquad ( 1 )$$

$$Y < 0.5 \qquad ( 2 )$$

$$Y \geq 1. 5 X - 1.04 \qquad ( 3 )$$

where X represents a circularity of the resin particle and Y represents a loose apparent density (g/cm³) of the resin particle.

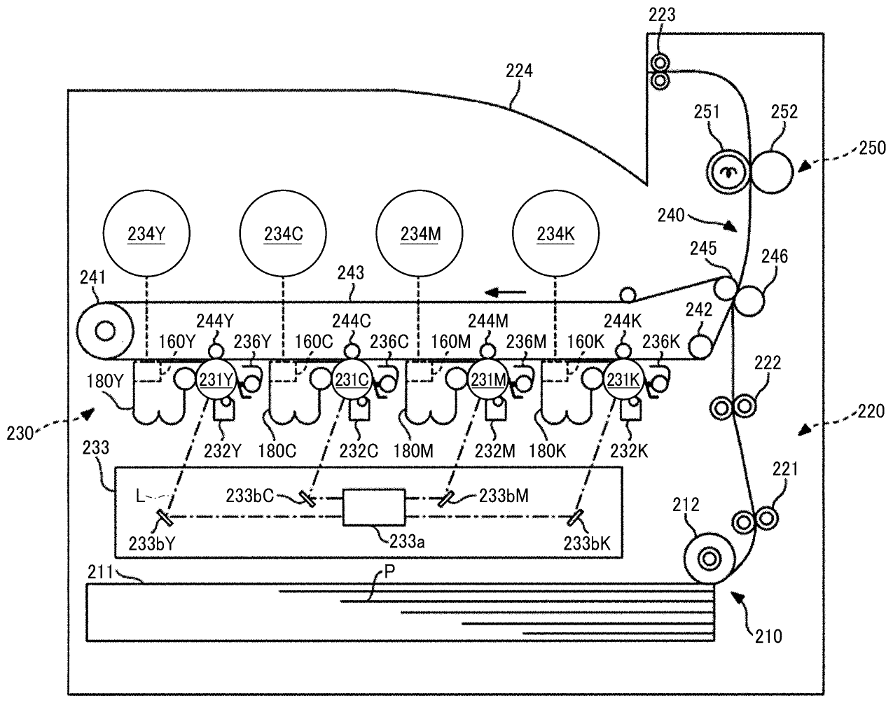

### CROSS-REFERENCE TO RELATED APPLICATIONS

This patent application is based on and claims priority pursuant to 35 U.S.C. § 119 (a) to Japanese Patent Application No. 2024-072853, filed on Apr. 26, 2024, in the Japan Patent Office, the entire disclosure of which is hereby incorporated by reference herein.

### BACKGROUND

### Technical Field

The present disclosure relates to a resin particle, a toner, and an image forming apparatus.

### Related Art

In recent years, to meet a demand for high image quality equivalent to that of offset printing, a toner having a small particle diameter and a nearly spherical shape formed by a polymerization method or the like (hereinafter sometimes referred to as “polymerization toner”) is used. The polymerization toner has a feature such as a higher transfer efficiency than a conventional pulverization toner, and may therefore meet the above demand. However, it is difficult to sufficiently remove the polymerization toner from a surface of an image bearer by using a cleaning blade, which causes poor cleaning. This is because the polymerization toner having a small particle diameter and an excellent sphericity, slips through a small gap formed between the cleaning blade and the image bearer.

### SUMMARY

The present disclosure described herein provides a resin particle that includes a binder resin comprising a polyester resin. The resin particle has a volume average particle diameter of 4.5 μm or more and 6.0 μm or less, the resin particle has an adhesive strength of 150 gf or less, and the resin particle satisfies the following relational expressions (1) to (3):

$$0.93 \leq X \leq 0 \text{.980} \qquad ( 1 )$$

$$Y < 0.5 \qquad ( 2 )$$

$$Y \geq 1. 5 X - 1.04 \qquad ( 3 )$$

where X represents a circularity of the resin particle and Y represents a loose apparent density (g/cm³) of the resin particle.

### BRIEF DESCRIPTIONS OF THE DRAWING

A more complete appreciation of embodiments of the present disclosure and many of the attendant advantages and features thereof can be readily obtained and understood from the following detailed description with reference to the accompanying drawing, wherein:
the drawing is a schematic view illustrating an example of an image forming apparatus according to an embodiment of the present disclosure.

The accompanying drawing is intended to depict embodiments of the present disclosure and should not be interpreted to limit the scope thereof. The accompanying drawing is not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

Embodiments of the present invention provide a resin particle that provides high-quality images having good reproducibility of fine lines and free of image graininess, and that is less likely to slip through and can maintain good cleaning properties for an extended period of time.

A resin particle according to an embodiment of the present disclosure is used as a base particle of a toner. A polymerization toner having a small particle diameter and a spherical shape provides a high-quality image with a good fine line reproducibility, but has a problem with a cleanability.

As a result of intensive study, the inventors of the present invention have found that with respect to a toner having a small particle diameter and having a volume average particle diameter of 4.5 μm or more and 6.0 μm or less, when its circularity and loose apparent density are controlled within appropriate ranges, an appropriate dam formation occurs not only for its external additive but also for the toner itself during cleaning, and as a consequence, its cleanability can be improved.

The volume average particle diameter is more preferably 4.6 μm or more and to 5.6 μm or less.

The resin particle according to an embodiment of the present disclosure does not include magnetic particle. Therefore, a toner containing the resin particle according to an embodiment the present disclosure as a base particle is a non-magnetic toner.

The “resin particle” may be referred to as “toner”, below.

In a case of non-magnetic toner, the relationship between the circularity and the loose apparent density is generally such that, when reference character X indicates a circularity and reference character Y indicates a loose apparent density (g/cm³) of the toner, a value of the reference character Y is generally lower than 1.5×-1.04; however, the value of the reference character Y can be controlled by controlling the shape of the toner and the BET specific surface area that is a surface property of the toner. When the loose apparent density Y is increased than normal, a dam can be effectively formed on a cleaning blade.

A unit of a numerical value indicating the loose apparent density is “g/cm³”, and will be omitted in the descriptions below.

When the loose apparent density is 0.5 or more, a dam layer of the toner is too large, so that a load applied on the cleaning blade is large, and thus, the cleaning blade is turned over. When the loose apparent density is too small, the dam layer of the toner is insufficiently formed, and the toner slips through a small gap between the dam layer and the cleaning blade. In such a case, when the toner has a low circularity, the toner cannot easily roll, so it is sufficient that the dam layer is small. However, when the toner has a high circularity, the toner easily slips through the gap, so a large dam layer is needed. The loose apparent density is more preferably 0.40 or more and 0.48 or less, and further preferably 0.42 or more and 0.45 or less.

When a toner adhesion force is set to 150 gf or less, an appropriate dam layer size can be maintained, and an excessive toner aggregation can be prevented in an image quality, thus preventing the occurrence of an image unevenness such as image graininess.

When the circularity of the toner is less than 0.930, a fine line reproducibility in an image deteriorates, and when the circularity exceeds 0.980, a cleanability deteriorates.

When a polyester resin as a binder resin of the toner includes a large amount of polyester resin derived from an aliphatic monomer, it is preferable to blend polyethylene terephthalate (PET) for increasing a mechanical strength and for making a dam formed during cleaning much stronger.

When the binder resin is added with a sulfonate group, a chargeability is improved, an aggregation of the toner is prevented, a transfer efficiency is increased, and as a result, such a sulfonate group acts as an effective means for preventing the occurrence of image graininess. Such an addition improves viscoelasticity of the outermost surface and also increases the mechanical strength, which is effective in forming the dam during cleaning.

To produce a toner having target circularity and loose apparent density, a production method including the steps of preparing a solution in which a binder resin and a colorant are dissolved or dispersed in an organic solvent, adding water to the solution to invert a phase from a water-in-oil dispersion to an oil-in-water dispersion, and aggregating fine particles of the oil-in-water dispersion, is easier to control the shape, hence effective.

A resin particle according to an embodiment of the present disclosure and a toner including such a resin particle as a base particle will be described in detail below. It is noted that the present disclosure is not limited to an embodiment described below, may be changed within the scope conceivable by a person skilled in the art, including other embodiments, additions, modifications, omissions, and the like, and such modified embodiments are included within the scope of the present disclosure, as long as the operations and effects of the present disclosure are achieved in any aspect.

### <Resin Particle>

The resin particle according to an embodiment of the present disclosure includes a polyester resin as a binder resin.

The resin particle has a volume average particle diameter of 4.5 μm or more and 6.0 μm or less, and an adhesive strength of 150 gf or less. The toner satisfies the following relational expressions (1) to (3):

$$0.93 \leq X \leq 0 \text{.980} \qquad ( 1 )$$

$$Y < 0.5 \qquad ( 2 )$$

$$Y \geq 1. 5 X - 1.04 \qquad ( 3 )$$

where X represents a circularity of the resin particle and Y represents a loose apparent density (g/cm³) of the resin particle.

The resin particle according to an embodiment of the present disclosure can be produced by gradually adding components, such as a resin and a colorant, in an organic solvent being stirred, dissolving or dispersing the components in the organic solvent to prepare an oil phase, and then, adding an aqueous phase to the oil phase, followed by the processes of phase inversion emulsification, solvent removal, aggregating, and fusing.

The components used in preparing the oil phase will be described below.

### <Amorphous Polyester Resin>

The polyester resin is preferably an amorphous polyester resin, more preferably a linear polyester resin, and further preferably an unmodified polyester resin.

The unmodified polyester resin is a polyester resin obtained by using a polyalcohol, and a polycarboxylic acid such as a polycarboxylic acid, a polycarboxylic anhydride, and a polycarboxylic ester, or a derivative thereof, and is not modified with an isocyanate compound or the like.

The amorphous polyester resin preferably includes a dicarboxylic acid component as a constituent component, and the dicarboxylic acid component preferably includes 50 mol % or more of a terephthalic acid. This is advantageous in terms of a heat-resistant storage stability.

An example of the polyalcohol includes, but is not limited to, a diol.

Examples of the diol include, but are not limited to, alkylene oxide adducts of bisphenol A (number of alkylene carbon atoms from 2 to 3; average number of moles added: 1 to 10) such as polyoxypropylene (2.2)-2,2-bis(4-hydroxyphenyl) propane and polyoxyethylene (2.2)-2,2-bis(4-hydroxyphenyl) propane; ethylene glycol, propylene glycol; hydrogenated bisphenol A, and alkylene oxide adducts of hydrogenated bisphenol A (number of alkylene carbon atoms from 2 to 3; average number of moles added: 1 to 10).

Such materials may be used alone or in combination of two or more types.

An example of the polycarboxylic acid includes, but is not limited to, a dicarboxylic acid.

Examples of the dicarboxylic acid include, but are not limited to, adipic acid, phthalic acid, isophthalic acid, terephthalic acid, fumaric acid, maleic acid; and succinic acids substituted with an alkyl group having 1 to 20 carbon atoms or an alkenyl group having 2 to 20 carbon atoms, such as dodecenylsuccinic acid and octylsuccinic acid.

Such materials may be used alone or in combination of two or more types.

For the purpose of adjusting an acid value and hydroxyl value, the amorphous polyester resin may include at least one of a trivalent or higher carboxylic acid and a trivalent or higher hydric alcohol at an end of the resin chain.

Examples of the trivalent or higher carboxylic acid include, but are not limited to, a trimellitic acid, a pyromellitic acid, and an acid anhydride thereof.

Examples of the trivalent or higher alcohol include, but are not limited to, glycerin, pentaerythritol, and trimethylolpropane.

A molecular weight of the amorphous polyester resin is not particularly limited and can be appropriately selected for any purpose. A weight average molecular weight (Mw) measured by gel permeation chromatography (GPC) is preferably 3,000 to 10,000. A number average molecular weight (Mn) is preferably from 1,000 to 4,000. Mw/Mn is preferably from 1.0 to 4.0.

When the molecular weight is equal to or more than the lower limit, heat-resistant storage stability of the toner and durability of the toner against a stress such as stirring in a developing machine can be prevented from decreasing. When the molecular weight is equal to or less than the upper limit, a viscoelasticity of the toner when melted can be prevented from increasing, and a fixability at low temperatures can be prevented from decreasing.

The weight average molecular weight (Mw) is more preferably from 4,000 to 7,000. The number average molecular weight (Mn) is more preferably from 1,500 to 3,000. The Mw/Mn is more preferably from 1.0 to 3.5.

An acid value of the amorphous polyester resin is not particularly limited and can be appropriately selected for any purpose. The acid value is preferably 1 mgKOH/g or more and 50 mgKOH/g or less, and more preferably 5 mgKOH/g or more and 30 mgKOH/g or less. When the acid value is 1 mgKOH/g or more, the toner tends to be negatively charged, and further, when the toner is fixed onto paper, an affinity between the paper and the toner is improved, and a fixability at low temperatures can be improved. When the acid value is 50 mgKOH/g or less, charging stability, particularly charging stability against an environmental change, can be prevented from decreasing.

A hydroxyl value of the amorphous polyester resin is not particularly limited and may be appropriately selected for any purpose, but is preferably 5 mgKOH/g or more.

A glass transition temperature (Tg) of the amorphous polyester resin is preferably 40° C. or more and 80° C. or less, and more preferably 50° C. or more and 70° C. or less. When the glass transition temperature is 40° C. or higher, the toner has a sufficient heat-resistant storage stability and durability against a stress such as stirring in a developing machine, and also has a good filming resistance. When the glass transition temperature is 80° C. or less, a deformation due to heating and pressing during a toner fixing is sufficient, and a fixability at low temperatures is good.

A molecular structure of the amorphous polyester resin can be confirmed by a nuclear magnetic resonance (NMR) measurement of a solution or a solid, as well as by X-ray diffraction, gas chromatography/mass spectrometry (GC/MS), liquid chromatography/mass spectrometry (LC/MS), an infrared absorption spectrometry (IR) measurement, and the like. An example of a simple method includes detecting, as an amorphous polyester resin, a resin not having absorption at 965±10 cm⁻¹ and 990±10 cm⁻¹ based on olefin δCH (out-of-plane bending vibration) in an infrared absorption spectrum.

A content of the amorphous polyester resin is not particularly limited and can be appropriately selected for any purpose, but is preferably 50 parts by mass to 90 parts by mass, and more preferably 60 parts by mass to 80 parts by mass, based on 100 parts by mass of the toner. When the content is 50 parts by mass or more, a dispersibility of a pigment and a release agent in the toner is prevented from deteriorating, and the occurrence of fog and distortion of an image can be prevented.

### <Repeating Unit Derived From Polyethylene Terephthalate (PET)>

The polyester resin according to an embodiment of the present disclosure may include, in addition to the above components, a repeating unit derived from polyethylene terephthalate (PET) that is a condensation product of terephthalic acid and ethylene glycol. As used herein, the “repeating unit derived from polyethylene terephthalate (PET)” may be referred to as a “PET repeating unit”.

The polyester resin including the PET repeating unit has an excellent mechanical durability and can therefore be suitably used. From the viewpoint of reducing an environmental burden, such as reducing an amount of petroleum resources used, it is preferable to use recycled PET as the PET, which is collected for recycle as a raw material.

The polyester resin including the PET repeating unit can be obtained by polycondensation while causing an ester exchange reaction with the above-mentioned polyester resin material.

### (Crystalline Resin)

It is preferable to add a crystalline resin to the toner according to an embodiment of the present disclosure to improve a fixability at low temperatures.

The crystalline resin is not particularly limited and can be appropriately selected for any purpose, as long as the crystalline resin has crystallinity. Examples of the crystalline resin include, but are not limited to, polyester resins, polyurethane resins, polyurea resins, polyamide resins, polyether resins, vinyl resins, and modified crystalline resins. Such materials may be used alone or in combination of two or more types.

### (Crystalline Polyester Resin)

The crystalline polyester resin will be described, below.

The crystalline polyester resin (hereinafter, sometimes referred to as “crystalline polyester resin C”) has a high crystallinity and therefore exhibits a heat melting characteristic showing a rapid change in viscosity near a fixing start temperature.

When the crystalline polyester resin C having such a characteristic is used together with the amorphous polyester resin, a toner having both a good heat-resistant storage stability and fixability at low temperatures can be obtained.

For example, in used together, a heat-resistant storage stability is good due to a crystallinity up to immediately before a melting start temperature, and at the melting start temperature, a sudden viscosity drop (sharp melt property) occurs due to a melting of the crystalline polyester resin C, which in turn becomes compatible with the above-described amorphous polyester resin B, and both rapidly decrease in viscosity, allowing for a good fixation.

The crystalline polyester resin can be obtained from a polyalcohol and a polycarboxylic acid or a derivative thereof, such as a polycarboxylic acid, a polycarboxylic anhydride, or a polycarboxylic ester. It is noted that in the present disclosure, the crystalline polyester resin refers to a resin obtained by using a polyalcohol and a polycarboxylic acid or a derivative thereof, such as a polycarboxylic acid, a polycarboxylic anhydride, or a polycarboxylic ester, as described above. Modified polyester resins, such as prepolymers and resins obtained by subjecting the prepolymers to a crosslinking and/or elongation reaction, do not belong to the crystalline polyester resin.

### <<Polyhydric Alcohol>>

The polyalcohol is not particularly limited and can be appropriately selected for any purpose. Examples of the polyalcohol include, but are not limited to, diols and trivalent or higher alcohols. An example of the diols includes, but is not limited to, saturated aliphatic diols. Examples of the saturated aliphatic diols include, but are not limited to, straight-chain saturated aliphatic diols and branched-chain saturated aliphatic diols. Among these, straight-chain saturated aliphatic diols are preferred, and straight-chain saturated aliphatic diols having 2 to 12 carbon atoms are more preferred. When the saturated aliphatic diol has a branched-chain structure, the crystallinity of the crystalline polyester resin decreases, and the melting point may decrease. Moreover, when the number of carbon atoms in the saturated aliphatic diol exceeds 12, it is difficult to acquire a material suitable for practical use.

Examples of the saturated aliphatic diol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among such saturated aliphatic diols, ethylene glycol, 1,4-butanediol, 1,6-hexanediol, 1,8-octanediol, 1,9-nonanediol, 1,10-decanediol, and 1,12-dodecanediol are preferred to impart the crystalline polyester resin with a high crystallinity and an excellent sharp melting property.

Examples of the trivalent or higher alcohol include, but are not limited to, glycerin, trimethylolethane, trimethylolpropane, and pentaerythritol. Such alcohols may be used alone or in combination of two or more types.

### <<Polycarboxylic Acid>>

The polycarboxylic acid is not particularly limited and may be appropriately selected for any purpose. Examples thereof include, but are not limited to, divalent carboxylic acids and trivalent or higher carboxylic acids. Examples of the divalent carboxylic acid include, but are not limited to, saturated aliphatic dicarboxylic acids such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; and aromatic dicarboxylic acids such as phthalic acid, isophthalic acid, terephthalic acid, naphthalene-2,6-dicarboxylic acid, malonic acid, and mesaconic acid. Further examples include, but are not limited to, anhydrides and lower (number of carbon atoms from 1 to 3) alkyl esters of such divalent carboxylic acids.

In particular, from the viewpoint of carbon neutrality, plant-derived saturated aliphatic compounds having 12 or less carbon atoms are preferred.

Examples of the trivalent or higher carboxylic acids include, but are not limited to, 1,2,4-benzenetricarboxylic acid, 1,2,5-benzenetricarboxylic acid, and 1,2,4-naphthalenetricarboxylic acid, as well as, anhydrides and lower (number of carbon atoms from 1 to 3) alkyl esters of such carboxylic acids. Such carboxylic acids may be used alone or in combination of two or more types.

The crystalline polyester resin preferably includes a straight-chain saturated aliphatic dicarboxylic acid having 4 to 12 carbon atoms and a straight-chain saturated aliphatic diol having 2 to 12 carbon atoms. This provides a high crystallinity and excellent sharp melting property, and thus, excellent fixability at low temperatures can be obtained.

Further, an example of a method of controlling the crystallinity and the softening point of a crystalline polyester resin includes the following method. That is, the method includes designing and using a non-linear polyester and the like, obtained by adding a trivalent or higher polyalcohol such as glycerin to the alcohol component, or a trivalent or higher polycarboxylic acid such as trimellitic anhydride to the acid component during polyester synthesis, and performing condensation polymerization.

The molecular structure of the crystalline polyester resin according to the present disclosure can be determined by an NMR measurement of a solution or solid, as well as X-ray diffraction, GC/MS, LC/MS, an IR measurement, and the like. An example of a simple method includes detecting a resin having absorption at 965±10 cm⁻¹ or 990±10 cm⁻¹ based on olefin δCH (out-of-plane bending vibration) in an infrared absorption spectrum.

Regarding the molecular weight, as a result of careful consideration, from the viewpoint that a crystalline polyester resin having the above-described sharp molecular weight distribution and a low molecular weight has an excellent fixability at low temperatures, and a crystalline polyester resin having a large amount of components with low molecular weight has a poor heat-resistant storage stability, it is preferable that in a molecular weight distribution of a soluble matter in o-dichlorobenzene by GPC, a molecular weight distribution chart, in which a horizontal axis is log (M) and a vertical axis is weight percent, has a peak position in a range of 3.5 to 4.0, a half width of the peak is 1.5 or less, a weight average molecular weight (Mw) is from 3,000 to 30,000, a number average molecular weight (Mn) is from 1,000 to 10,000, and Mw/Mn is 1 to 10. It is more preferable that the weight average molecular weight (Mw) is 5,000 to 15,000, the number average molecular weight (Mn) is 2,000 to 10,000, and Mw/Mn is 1 to 5.

It is preferable that from the viewpoint of an affinity between the paper and the resin, the acid value of the crystalline polyester resin is 5 mgKOH/g or more to achieve a target fixability at low temperatures, it is more preferable that for a preparation of fine particles by phase inversion emulsification, the acid value is 7 mg KOH/g or more, and on the other hand, to improve a hot offset property, it is preferable that the acid value is 45 mgKOH/g or less. To achieve a desired fixability at low temperatures and a good chargeability, the hydroxyl value of crystalline polymers is preferably 0 mgKOH/g or more and 50 mgKOH/g or less, and is more preferably 5 mgKOH/g or more and 50 mgKOH/g or less.

### (Colorant)

For the colorant in the present disclosure, known dyes and pigments can be used. Specific examples of the colorant include, but are not limited to, known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarin Lake, Thioindigo Red B, Thioindigo Maroon, Oil Red, Quinacridone Red, Pyrazolone Red, polyazo red, Chrome Vermilion, Benzidine Orange, Perinone Orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, and combinations thereof.

### (Organic Solvent)

The organic solvent is preferably volatile and has a boiling point of less than 100° C. because such a feature makes it easier to remove the organic solvent later.

Examples of such an organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, methanol, ethanol, and isopropyl alcohol, which can be used alone or in combination of two or more. When the resin to be dissolved or dispersed in an organic solvent is a resin having a polyester skeleton, it is preferable to use an ester-based solvent such as methyl acetate, ethyl acetate, or butyl acetate, or a ketone-based solvent such as methyl ethyl ketone or methyl isobutyl ketone, to obtain a high solubility. In particular, methyl acetate, ethyl acetate, and methyl ethyl ketone, which have a high solvent removability, are particularly preferable.

### (Prepolymer)

The oil phase in a process for producing the resin particle according to an embodiment of the present disclosure may include a prepolymer.

The prepolymer produces a polyester resin (referred to as “polyester resin D”) during a suspension polymerization.

An example of reactive precursors includes, but is not limited to, a polyester having a group reactive with an active hydrogen group.

An example of the group reactive with the active hydrogen group includes, but is not limited to, an isocyanate group, an epoxy group, a carboxylic acid group, and an acid chloride group. In particular, an isocyanate group is preferred because it is capable of introducing a urethane bond or a urea bond into the amorphous polyester resin.

The reactive precursor may have a branched structure imparted by at least one of a trivalent or higher alcohol and a trivalent or higher carboxylic acid.

An example of the polyester resin containing an isocyanate group may include, but is not limited to, a reaction product of a polyester resin having an active hydrogen group with a polyisocyanate. For example, the polyester resin having an active hydrogen group may be obtained by polycondensation of a diol, a dicarboxylic acid, and at least one of a trivalent or higher alcohol and a trivalent or higher carboxylic acid. The trivalent or higher alcohol and the trivalent or higher carboxylic acid impart a branched structure to the polyester resin containing an isocyanate group.

Examples of the diol include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol, and 1,12-dodecanediol; diols having an oxyalkylene group such as diethylene glycol, triethylene glycol, dipropylene glycol, polyethylene glycol, polypropylene glycol, and polytetramethylene glycol; alicyclic diols such as 1,4-cyclohexanedimethanol and hydrogenated bisphenol A; diol components obtained by adding alkylene oxides such as ethylene oxide, propylene oxide, and butylene oxide to alicyclic diols; bisphenols such as bisphenol A, bisphenol F, and bisphenol S; and alkylene oxide adducts of bisphenols obtained by adding alkylene oxides such as ethylene oxide, propylene oxide, and butylene oxide to bisphenols. In particular, from the viewpoint of controlling the glass transition temperature of the polyester resin D to 20° C. or lower, it is preferable to use an aliphatic diol having 3 to 10 carbon atoms, such as 1,2-propylene glycol, 1,3-propylene glycol, 1,4-butanediol, 2-methyl-1,3-propanediol, 1,5-pentanediol, and 3-methyl-1,5-pentanediol, and it is more preferable to use 50 mol % or more of the alcohol component in the resin. These diols may be used alone or in combination of two or more types.

The polyester resin obtained by extending the prepolymer is preferably the amorphous polyester resin, and when a steric hindrance is provided in the resin chain, which reduces a melt viscosity during fixing, it is easier to obtain a fixability at low temperatures. Therefore, the main chain of the aliphatic diol preferably has a structure represented by General Formula (1) below.

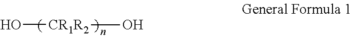

[where R₁ and R₂ each independently represent a hydrogen atom or an alkyl group having 1 to 3 carbon atoms, and n represents an odd number from 3 to 9. However, in the n repeating units, R₁ and R₂ may be the same or different.]

Here, the main chain of the aliphatic diol according to an embodiment of the present disclosure refers to the carbon chain in which two hydroxyl groups contained in the aliphatic diol are linked via the lowest number of carbon atoms. It is preferable that the main chain has an odd number of carbon atoms, because the odd-even properties reduce crystallinity. Further, it is more preferable that the side chain has at least one or more alkyl groups having 1 to 3 carbon atoms, because the interaction energy between molecules in the main chain is reduced by the stereoscopic properties.

Examples of the dicarboxylic acids include, but are not limited to, aliphatic dicarboxylic acids such as succinic acid, adipic acid, sebacic acid, dodecanedioic acid, maleic acid, and fumaric acid; and aromatic dicarboxylic acids such as phthalic acid, isophthalic acid, terephthalic acid, and naphthalenedicarboxylic acid. Further, anhydrides, lower (number of carbon atoms from 1 to 3) alkyl esters, and halides of such dicarboxylic acids may also be used. In particular, from the viewpoint of controlling the Tg of the polyester resin D to 20° C. or lower, aliphatic dicarboxylic acids having 4 to 12 carbon atoms are preferred, and it is more preferable to use 50% by mass or more of the carboxylic acid components in the resin. Such dicarboxylic acids may be used alone or in combination of two or more types.

Examples of the trivalent or higher alcohols include, but are not limited to, trivalent or higher aliphatic alcohols such as glycerin, trimethylolethane, trimethylolpropane, pentaerythritol, and sorbitol; trivalent or higher polyphenols such as trisphenol PA, phenol novolac, and cresol novolac; and alkylene oxide adducts of trivalent or higher polyphenols, such as adducts obtained by adding alkylene oxides such as ethylene oxide, propylene oxide, and butylene oxide to trivalent or higher polyphenols.

Examples of the trivalent or higher carboxylic acids include, but are not limited to, trivalent or higher aromatic carboxylic acids, and preferred examples include, but are not limited to, trivalent or higher aromatic carboxylic acids having 9 to 20 carbon atoms, such as trimellitic acid and pyromellitic acid. Further, anhydrides, lower (number of carbon atoms from 1 to 3) alkyl esters, and halides of such carboxylic acids may also be used.

Examples of the polyisocyanate include, but are not limited to, diisocyanates and trivalent or higher isocyanates.

The polyisocyanate is not particularly limited and can be appropriately selected for any purpose. Examples of the polyisocyanate include, but are not limited to, 1,3- and/or 1,4-phenylene diisocyanate, 2,4- and/or 2,6-tolylene diisocyanate (TDI), crude TDI, 2,4′- and/or 4,4′-diphenylmethane diisocyanate (MDI), crude MDI [phosgenates of crude diaminophenylmethane [condensation product of formaldehyde with aromatic amine (aniline) or a mixture thereof; a mixture of diaminodiphenylmethane and a small amount (for example, 5 to 20% by mass) of trifunctional or higher polyamine]: polyallyl polyisocyanate (PAPI)]; aromatic diisocyanates such as 1,5-naphthylene diisocyanate, 4,4′,4″-triphenylmethane triisocyanate, and m- and p-isocyanatophenylsulfonyl isocyanate; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; alicyclic diisocyanates such as isophorone diisocyanate (IPDI), dicyclohexylmethane-4,4′-diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate, and 2,5- and 2,6-norbornane diisocyanate; araliphatic diisocyanates such as m- and p-xylylene diisocyanate (XDI) and α,α,α′,α′-tetramethylxylylene diisocyanate (TMXDI); trivalent or higher polyisocyanates such as lysine triisocyanate and diisocyanate-modified products of trivalent or higher alcohols; and modified products of these isocyanates, as well as mixtures of two or more thereof. Examples of the modified products of the isocyanates include, but are not limited to, modified products containing a urethane group, a carbodiimide group, an allophanate group, a urea group, a burette group, a uretdione group, a uretimine group, an isocyanurate group, and an oxazolidone group.

### <Core-Shell Structure>

The resin particle has a core-shell structure including a core layer and a shell layer. A shell resin included in the shell layer is preferably an amorphous polyester resin A described below, and an amorphous polyester resin contained in the core is preferably an amorphous polyester resin B described below.

As used herein, “a core-shell structure” means a structure including a core layer and a shell layer, the “shell layer” means a layer including a resin present in an outermost layer of the resin particles, and the “core layer” means a region within the resin particle excluding the shell layer.

The core layer and the shell layer are not completely compatible with each other and are formed inhomogeneously.

In the core-shell structure, a surface of the core layer is preferably covered with the shell layer.

In the core-shell structure, the surface of the core layer may or may not be completely covered by the shell layer. Examples of a mode in which the surface of the core layer is not completely covered with the shell layer include a mode in which the core layer is covered with the shell layer in a mesh-like pattern, and a mode in which the core layer is partially exposed from the shell layer. In particular, from the viewpoint of a heat-resistant storage stability, it is preferable that the surface of the core layer is completely covered with the shell layer.

In the resin particle according to an embodiment of the present disclosure, the resin particle includes an amorphous polyester resin serving as a binder resin, forms the core-shell structure, and the shell layer includes at least a polyester resin including a sulfonate group. The resin particle according to an embodiment of the present disclosure includes the core-shell structure including the core layer and the shell layer to ensure a heat-resistant storage stability.

When the shell layer is formed of a polyester resin containing a sulfonate group, a high charging performance can be obtained due to a charging effect of the sulfonate group. With a viscoelasticity imparting effect of the sulfonate group, a strength of the toner can be supplemented, and thus, both a fixability at low temperatures and a storage stability can be achieved while maintaining a high carbon neutrality.

### (Polyester Resin Containing Sulfonate Group)

An alcohol and a carboxylic acid used in synthesizing the polyester resin containing a sulfonate group are not particularly limited. Examples of a constituent component include, but are not limited to, a polyalcohol and a polycarboxylic acid exemplified in the description of the <Amorphous Polyester Resin>.

### (Monomer Containing Sulfonate Group)

In synthesizing the polyester resin containing a sulfonate group, a monomer containing a sulfonate group is used. Examples of the monomer containing a sulfonate group include, but are not limited to, a monomer containing an aromatic sulfonate group and a monomer containing an aliphatic sulfonate group. In particular, the monomer containing an aromatic sulfonate group having a divalent or higher carboxylic acid is preferred.

Examples of aromatic dicarboxylic acids containing a sulfonate group include, but are not limited to, 5-sulfoisophthalic acid, 2-sulfoisophthalic acid, 4-sulfoisophthalic acid, 4-sulfo-2,6-naphthalenedicarboxylic acid, and sulfonates of ester-forming derivatives thereof (e.g., lower alkyl (C1-4) esters (such as methyl esters and ethyl esters), acid anhydrides).

Examples of an aliphatic dicarboxylic acid having a sulfo group include, but are not limited to, sulfosuccinic acid and sulfonates of ester-forming derivatives thereof (e.g., lower alkyl (C1-4) esters (such as methyl esters and ethyl esters), acid anhydrides).

Examples of sulfonates include, but are not limited to, salts of alkali metals (such as lithium, sodium, and potassium), salts of alkaline earth metals (such as magnesium and calcium), ammonium salts, amine salts such as mono-, di-, and tri-amines having hydroxyalkyl (C2-4) groups (organic amines salts such as mono-, di-, and triethylamine, mono-, di-, and triethanolamine, and diethylethanolamine), quaternary ammonium salts of these amines, and combinations of two or more thereof.

In particular, 5-sulfoisophthalic acid salts are preferred, and 5-sulfoisophthalic acid sodium salt and 5-sulfoisophthalic acid potassium salt are particularly preferred.

An electrostatic charge control agent and the like may be added to the oil phase.

### (Electrostatic Charge Control Agent)

Any well-known electrostatic charge control agent may be used, and examples thereof include, but are not limited to, nigrosine-based dyes, triphenylmethane-based dyes, chromium-containing metal complex dyes, molybdate chelate pigments, rhodamine-based dyes, alkoxy-based amines, quaternary ammonium salts (including fluorine-modified quaternary ammonium salts), alkylamides, elemental phosphorus or phosphorus compounds, elemental tungsten or tungsten compounds, fluorine-based activators, metal salts of salicylic acid, and metal salts of salicylic acid derivatives. Specific examples of the electrostatic charge control agent include, but are not limited to, the nigrosine-based dye BONTRON® 03, the quaternary ammonium salt BONTRON® P-51, the metal-containing azo dye BONTRON® S-34, the oxynaphthoic acid-based metal complex E-82, the salicylic acid-based metal complex E-84, the phenolic condensate E-89 (all manufactured by Orient Chemical Industries Co., Ltd.), the quaternary ammonium salt molybdenum complexes TP-302 and TP-415 (both manufactured by Hodogaya Chemical Co., Ltd.), the quaternary ammonium salt copy charge PSY VP2038, the triphenylmethane derivative copy blue PR, the quaternary ammonium salt copy charge NEG VP2036, the copy charge NX VP434 (all manufactured by Hoechst AG), LRA-901, the boron complex LR-147 (manufactured by Japan Carlit Co., Ltd.), copper phthalocyanine, perylene, quinacridone, azo pigments, and in addition, polymeric compounds having functional groups such as sulfonic acid groups, carboxyl groups, and quaternary ammonium salts. It is sufficient that the electrostatic charge control agent is used in an amount within a range in which it can exhibit a performance without interfering with a fixability and the like, and is preferably contained in the toner in an amount of 0.5% to 5% by mass, preferably 0.8% to 3% by mass.

### (Release Agent)

A release agent is not particularly limited and can be appropriately selected for any purpose, but a release agent having a low melting point of 50° C. to 120° C. is preferred. When dispersed from the resin, the release agent having a low melting point effectively acts at a gap between a fixing roller and a toner interface, so that a good hot offset property is obtained, even in an oil-less system (in which no release agent such as oil is applied to the fixing roller).

Suitable example of the release agent includes, but is not limited to, waxes. Examples of the waxes include, but are not limited to, natural waxes including plant-based waxes such as carnauba wax, cotton wax, Japan wax, and rice wax; animal-based waxes such as beeswax and lanolin; mineral-based waxes such as ozokerite and cerecin; and petroleum waxes such as paraffin, microcrystalline wax, and petrolatum. In addition to such natural waxes, examples of waxes include, but are not limited to, synthetic hydrocarbon waxes such as Fischer-Tropsch wax and polyethylene wax; and synthetic waxes such as esters, ketones, and ethers. Further, fatty acid amides such as 12-hydroxystearamide, stearamide, phthalimide anhydride, and chlorinated hydrocarbons; polyacrylate homopolymers or copolymers such as poly-n-stearyl methacrylate and poly-n-lauryl methacrylate, which are crystalline polymer resins having low molecular weight (for example, n-stearyl acrylate-ethyl methacrylate copolymer); and crystalline polymers having long alkyl groups in a side chain may also be used as the wax. Such waxes may be used alone or in combination of two or more types.

The melt viscosity of wax obtained as a value measured at a temperature 20° C. higher than the melting point of the wax, is preferably 5 cps to 1,000 cps, and more preferably 10 cps to 100 cps.

When the melt viscosity is 5 cps or more, a decrease of the releasability can be prevented, and when the melt viscosity is 1,000 cps or less, the effects of hot offset resistance and fixability at low temperatures can be sufficiently exhibited. The content of the wax in the toner is not particularly limited and may be appropriately selected for any purpose, but is preferably from 0% or more by mass to 40% or less by mass, and more preferably from 3% or more by mass to 30% or less by mass.

### <Method of Manufacturing Resin Particles>

Preferably, the resin particle is granulated in an aqueous medium. Specific examples of such a granulation method performed in an aqueous medium include, but are not limited to, suspension polymerization methods, emulsion polymerization aggregation methods, phase inversion emulsion aggregation methods, and dissolution suspension methods. Among these, phase inversion emulsion aggregation methods are preferred.

A method of manufacturing a resin particle according to one embodiment will be described. The method of manufacturing a resin particle according to one embodiment includes an oil phase preparing process, an aqueous phase preparing process, a phase inversion emulsification process, a solvent removal process, an aggregating process, and a fusing process, and if desired, further includes other processes such as a shell forming process, a washing process, a drying process, an annealing process, and an external addition process.

### (Oil Phase Preparing Process)

In the oil phase preparing process, first, a raw material of the toner, that is, the resin (an amorphous polyester resin, a crystalline polyester resin, and the like), and, as appropriate, a material such as a colorant, a prepolymer, and a wax are dissolved or dispersed in an organic solvent to prepare an oil phase. A part of the material may be added in the aggregating process described below.

A method of preparing an oil phase is not particularly limited and can be appropriately selected for any purpose. An example of the method includes a method in which a raw material such as a resin is gradually added to an organic solvent while stirring to dissolve or disperse the raw material.

To disperse the raw material, known dispersers such as a bead mill and a disk mill can be used.

The raw material used in the oil phase preparing process can be the same as that described above in relation to the components used in the oil phase preparing process. Such a raw material may be used alone or in combination of two or more types.

The organic solvent is not particularly limited and can be appropriately selected for any purpose. However, it is preferable to use a volatile solvent having a boiling point of less than 100° C., because it is easier to subsequently remove the organic solvent.

Examples of such organic solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, butyl acetate, methyl ethyl ketone, methyl isobutyl ketone, methanol, ethanol, and isopropyl alcohol. Such organic solvents may be used alone or in combination of two or more types.

When the resin to be dissolved or dispersed in the organic solvent is a resin having a polyester backbone, the organic solvent is preferably an ester-based solvent such as methyl acetate, ethyl acetate, and butyl acetate, or a ketone-based solvent such as methyl ethyl ketone and methyl isobutyl ketone, because the solubility is high. In particular, the organic solvent is preferably methyl acetate, ethyl acetate, or methyl ethyl ketone, because the organic solvent can be easily removed.

The amount of the organic solvent used is not particularly limited and can be appropriately selected for any purpose, but is preferably 40 parts by mass or more to 300 parts by mass or less, more preferably 60 parts by mass or more to 140 parts by mass or less, and even more preferably 80 parts by mass or more to 120 parts by mass or less, with respect to 100 parts by mass of the raw material of the resin particles.

### (Aqueous Phase Preparing Process)

In the aqueous phase preparing process, an aqueous phase (aqueous medium) is prepared.

The aqueous medium is not particularly limited and can be appropriately selected from known aqueous media. Examples of the aqueous medium include, but are not limited to, water, a solvent miscible with water, and a mixture thereof. From the viewpoint of a granulation property, the organic solvent concentration is preferably equal to or lower than a saturation concentration in ion-exchanged water.

The solvent miscible with water is not particularly limited, can be appropriately selected from known solvents, and examples thereof include, but are not limited to, alcohol, dimethylformamide, tetrahydrofuran, cellosolves, lower ketones, and esters.

Examples of the alcohol include, but are not limited to, methanol, isopropanol, and ethylene glycol.

Examples of lower ketones include, but are not limited to, acetone and methyl ethyl ketone.

An example of the esters includes, but is not limited to, ethyl acetate.

Such solvents may be used alone or in combination of two or more types.

### (Phase Inversion Emulsification Process)

In the phase inversion emulsification process, the oil phase obtained in the oil phase preparing process is formed into fine particles.

After neutralizing the oil phase, ion-exchanged water is added to the neutralized oil phase, and phase inversion emulsification, in which the water-in-oil dispersion liquid is inverted into an oil-in-water dispersion liquid, is caused to obtain a fine particle dispersion liquid.

The phase inversion emulsification is implemented while uniformly mixing and dispersing the mixture by using a general-use stirrer or a dispersing device.

A stirring blade is not particularly limited and can be appropriately selected according to the viscosity of the solution. Examples of the stirring blade include, but are not limited to, stirring blades for low viscosity such as paddles and propellers, stirring blades for medium viscosity such as anchors and MAXBLEND stirring blades, and stirring blades for high viscosity such as helical ribbons. The dispersing device is not particularly limited, and examples thereof include, but are not limited to, an ultrasonic disperser, a bead mill, a ball mill, a roll mill, a HOMOMIXER, an ULTRA MIXER, a disperser mixer, a penetrating-type high-pressure dispersion device, a collision-type high-pressure dispersion device, a multi-hole type high-pressure dispersion device, an ultra-high pressure homogenizer, and an ultrasonic homogenizer. A general-use stirrer and a dispersing device may be used in combination.

In particular, a paddle and an anchor are preferably used, because they are capable of controlling the volume average particle diameter of the dispersed body (oil droplets) within the above-mentioned preferred range.

As a base used for neutralizing the oil phase, any one of a basic inorganic compound or a basic organic compound may be used. Examples of the basic inorganic compound include, but are not limited to, sodium hydroxide, potassium hydroxide, lithium hydroxide, ammonia, sodium carbonate, sodium hydrogen carbonate, potassium carbonate, potassium hydrogen carbonate, and ammonia. Examples of the basic organic compound include, but are not limited to, N,N-dimethylethanolamine, N,N-diethylethanolamine, triethanolamine, tripropanolamine, tributanolamine, triethylamine, n-propylamine, n-butylamine, isopropylamine, monomethanolamine, morpholine, methoxypropylamine, pyridine, vinylpyridine, and isophoronediamine.

When a stirring blade is used, the conditions including a rotation speed, a stirring time, and a stirring temperature are not particularly limited and can be appropriately selected for any purpose.

The rotation speed is not particularly limited, but is preferably 100 rpm to 1,000 rpm, and more preferably 200 rpm to 600 rpm.

The stirring time and the stirring temperature are not particularly limited and may be appropriately selected for any purpose.

If desired, a dispersant may be used. The dispersant is not particularly limited and can be appropriately selected for any purpose. Examples of the dispersant include, but are not limited to, surfactants, inorganic compound dispersants poorly soluble in water, and polymer-based protective colloids. Such materials may be used alone or in combination of two or more types. In particular, surfactants are preferred.

The surfactants are not particularly limited, can be appropriately selected for any purpose, and examples thereof include, but are not limited to, anionic surfactants, cationic surfactants, nonionic surfactants, and amphoteric surfactants.

The anionic surfactants are not particularly limited, can be appropriately selected for any purpose, and examples thereof include, but are not limited to, alkylbenzene sulfonate, α-olefin sulfonate, and phosphoric acid ester. In particular, surfactants having a fluoroalkyl group are preferred.

### (Solvent Removal Process)

To remove the organic solvent from the obtained colored fine particle dispersion, a method can be adopted in which the temperature of the entire system is gradually raised while stirring, and the organic solvent in the droplets is completely evaporated and removed. Alternatively, the obtained colored fine particle dispersion may be sprayed into a dry atmosphere while stirring to completely remove the organic solvent from the droplets. Alternatively, the organic solvent may be evaporated and removed by reducing a pressure while stirring the colored fine particle dispersion. The latter two methods may be used in conjunction with the first method.

The drying atmosphere in which the colored fine particle dispersion is sprayed generally includes air, nitrogen, carbon dioxide, heated combustion gas, and the like, and in particular, various air streams heated to a temperature equal to or higher than the boiling point of the highest boiling point solvent used. The desired quality may be obtained by short processing using a spray dryer, belt dryer, rotary kiln, and the like.

Through the above methods, the colored fine particle dispersion can be obtained.

### (Aggregating Process)

Next, the resulting colored fine particle dispersion is aggregated with being stirred until the particles reach a desired particle diameter.

For aggregation, an existing method including adding an aggregating agent or adjusting the pH may be used. When an aggregating agent is added, the aggregating agent may be simply added. However, it is preferable to add the aggregating agent as an aqueous solution, because in such a case, a localized high concentration can be prevented. It is also preferable to gradually add coagulant salt while monitoring the particle diameter of the colored particles.

The temperature of the dispersion liquid during aggregation is preferably close to the Tg of the resin used. When the liquid temperature is too low, aggregation does not proceed very well, hence poor efficiency. When the liquid temperature is too high, the aggregation rate increases, resulting in the generation of coarse particles and a deterioration in particle diameter distribution.

When the desired particle diameter is obtained, the aggregation is stopped. A method for stopping the aggregation includes adding a salt with a low ionic valence or a chelating agent, adjusting the pH, lowering the temperature of the dispersion, and adding a large amount of an aqueous medium to dilute the concentration.

Through the above methods, a dispersion of colored aggregated particles can be obtained.

In the aggregating process, a release agent or a crystalline polyester resin may be added. In such a case, when a material to be added is mixed with a dispersion obtained by dispersing the material to be added in a water-based medium or the colored fine particle dispersion and then aggregated, aggregated particles in which the release agent and crystalline resin are uniformly dispersed can be obtained.

### (Aggregating Agent)

A well-known aggregating agent may be used. For example, metal salts of monovalent metals such as sodium and potassium, metal salts of divalent metals such as calcium and magnesium, and metal salts of trivalent metals such as iron and aluminum may be used.

### (Fusing Process)

Next, the obtained aggregated particles are fused by a heating treatment to reduce the unevenness to obtain spherical particles.

To fuse the aggregated particles, it is sufficient to heat the dispersion liquid of the colored aggregated particles while stirring the dispersion liquid. The temperature of the liquid is preferably close to a temperature higher than the Tg of the resin used.

### <Shell Forming Process>

As appropriate, the resultant particles may be formed into a shell. In the shell forming process, a shell layer is formed on the particles obtained in the aggregating process.

A method of forming the shell layer is not particularly limited and can be appropriately selected for any purpose. An example of the method of forming the shell layer includes, but is not limited to, a method in which spherical particles having a desired particle diameter are produced in the aggregating process, then, a non-crystalline resin is added, and the aggregating process and the fusing process are repeated to form the shell layer.

### (Washing and Drying Process)

The toner particle dispersion liquid obtained by the above-described method contains an auxiliary material such as coagulant salt, in addition to the toner particles. Therefore, in one example, the toner particle dispersion liquid is washed to extract the toner particles from the dispersion liquid. Methods of washing the toner particles are not particularly limited in the present disclosure and examples thereof include, but are not limited to, a centrifugation method, a vacuum filtration method, and a filter pressing method. All of the above-mentioned methods produce a cake body of the toner particles. In a case where the dispersion cannot be sufficiently washed in one operation, the obtained cake may be dispersed again in an aqueous solvent to form a slurry, and the process of extracting the toner particles by any of the above methods may be repeated. When the vacuum filtration method or the filter pressing method is used to wash the dispersion, a method may be adopted in which the aqueous solvent is passed through the cake to wash away an auxiliary material absorbed by the colored resin particles. Examples of the aqueous solvent used to wash the dispersion include, but are not limited to, water and a mixed solvent obtained by mixing water with an alcohol such as methanol or ethanol. From the viewpoint of a cost and an environmental impact due to a wastewater treatment, it is preferable to use water.

The washed toner particles contain a large amount of the aqueous medium, and thus, in one example, the aqueous medium may be removed by drying to obtain the toner particles. In the drying method, a dryer may be used, such as a spray dryer, a vacuum freeze dryer, a reduced pressure dryer, a stationary shelf dryer, a movable shelf dryer, a fluidized bed dryer, a rotary dryer, and an agitated dryer. The dried toner particles are preferably dried until the moisture content is finally reduced to less than 1%. When the colored resin particles after drying form soft aggregates and are inconvenient for use, the soft aggregates may be crushed by utilizing a device such as a jet mill, a HENSCHEL MIXER, a SUPER MIXER, a coffee mill, an OSTER blender, and a food processor to break up soft aggregates.

### (Annealing Process)

When a crystalline resin is added, the annealing treatment is performed after drying. As a result, a non-crystalline resin and a crystalline resin are phase-separated, so that the fixability increases. Specifically, it is sufficient to store the material at a temperature close to the Tg for ten hours or more.

### (External Addition Process)

To impart a fluidity, a chargeability, a cleanability, and the like to the toner particles obtained in the present disclosure, inorganic fine particles, polymeric fine particles, cleaning aids, and the like may be added thereto or mixed therewith.

Specific mixing methods include, but are not limited to, a method in which an impact force is applied to the mixture by a blade rotating at high speed, and a method in which the mixture is introduced into a high-speed air stream, accelerated, and the particles are caused to collide with each other or particles form composites are caused to collide with an appropriate collision plate. Examples of the device include, but are not limited to, ANGMILL® (manufactured by Hosokawa Micron Corporation), a device obtained by modifying an I-type mill (manufactured by Nippon Pneumatic Mfg. Co., Ltd.) to reduce the pulverizing air pressure, a HYBRIDIZATION SYSTEM (manufactured by Nara Machinery, Co., Ltd.), a KRYPTRON SYSTEM™ (manufactured by Kawasaki Heavy Industries, Ltd.), and an automatic mortar.

### (External Additives)

A primary particle diameter of the inorganic fine particles is preferably 5 nm to 2 μm, and more preferably 5 nm or more and 500 nm or less. A specific surface area as measured by the BET method is preferably 20 m²/g or more and 500 m²/g or less. A content of the inorganic fine particles is preferably 0.01% by mass or more and 5% by mass or less of the toner. Specific examples of the inorganic fine particles include, but are not limited to, silica, alumina, oxidized titanium, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride.

Examples of the polymeric fine particles include, but are not limited to, polystyrene obtained by soap-free emulsion polymerization, suspension polymerization, and dispersion polymerization, polycondensation products such as methacrylic acid ester and acrylic ester copolymers, silicone, benzoguanamine, and nylon, and polymer particles formed of a thermosetting resin.

With such fluidizing agents, a surface treatment is performed to increase a hydrophobicity, and as a result, a deterioration of a flowability and a chargeability can be prevented even under a high humidity condition. Examples of preferred surface treatment agents include, but are not limited to, silane coupling agents, silylating agents, silane coupling agents having a fluorinated alkyl group, organic titanate coupling agents, aluminum-based coupling agents, silicone oil, and modified silicone oil.

Examples of the cleanability improver to remove a transferred developer remaining in the photoconductor or the primary transfer medium include, but are not limited to, fatty acid metal salts such as zinc stearate, calcium stearate, and stearic acid, and polymer fine particles prepared by soap-free emulsion polymerization such as polymethyl methacrylate fine particles, and polystyrene fine particles. The polymer fine particles preferably have a relatively narrow particle size distribution, and preferably has a volume average particle diameter of from 0.01 μm to 1 μm.

The resin particles according to one embodiment, which have the above-mentioned properties, can be effectively used as materials for image formation, such as a toner, a developer, a toner set, a toner storage unit, and an image forming apparatus.

### <Toner>

The toner according to one embodiment includes the resin particle according to one embodiment, and may be formed of the resin particle according to one embodiment.

When the resin particle according to one embodiment is used in the toner, an environmental impact is reduced, and even when a plant-derived resin is used, an image having excellent fixability at low temperatures, chargeability and image quality can be provided.

### <Developer>

The developer according to one embodiment includes the toner according to one embodiment, and may include other components such as a carrier, which are appropriately selected as appropriate. Such a developer can stably form a high quality image having an excellent transferability and chargeability.

The developer may be a one-component developer or a two-component developer. However, when used in a high-speed printer and the like responding to an increased information processing speed in recent years, a two-component developer is preferred in the viewpoint of a longer service life.

When the toner according to one embodiment is used in the one-component developer, and even when the toner is consumed and resupplied, the particle diameter of the toner varies little, there is little filming of the toner on the developing roller, and the toner hardly fuses with components such as a blade used to obtain a thin layer of the toner. Therefore, a high quality image can be obtained in the developing device.

When the developer according to one embodiment is used as the two-component developer, such a developer may be mixed with a carrier and used as the developer. When the toner according to one embodiment is used as the two-component developer, the particle diameter of the toner varies little, even when the toner is consumed and resupplied over a long period of time. Therefore, good and stable developing properties and images can be obtained, even when the toner is stirred during a long period of time in the developing device.

A content of the carrier in the two-component developer can be appropriately selected for any purpose. However, the content is preferably 90 parts by mass to 98 parts by mass, and more preferably 93 parts by mass to 97 parts by mass, with respect to 100 parts by mass of the two-component developer.

The developer according to one embodiment can be suitably used to form images by various types of known electrophotographic methods such as a magnetic one-component development method, a non-magnetic one-component development method, and a two-component development method.

### [Carrier]

The carrier is not particularly limited and can be appropriately selected for any purpose. However, the carrier preferably includes a core material and a resin layer (covering layer) covering the core material.

### (Core Material)

A material of the core material is not particularly limited and can be appropriately selected for any purpose. Examples of the material include, but are not limited to, 50 emu/g to 90 emu/g of manganese-strontium based materials and 50 emu/g to 90 emu/g of manganese-magnesium based materials. To ensure image density, it is preferable to use a highly magnetized material such as 100 emu/g or more of iron powder and 75 emu/g to 120 emu/g of magnetite. Further, it is preferable to use 30 emu/g to 80 emu/g of a weakly magnetized material such as a copper-zinc based material, because it can alleviate the impact of the developer in an upright state on the photoconductor, which is advantageous for obtaining high image quality. Such materials may be used alone or in combination of two or more types.

The volume average particle diameter of the core material is not particularly limited and may be appropriately selected for any purpose, but is preferably from 10 μm to 150 μm, and more preferably from 40 μm to 100 μm. When the volume average particle diameter is 10 μm or more, an undesired phenomenon in which the amount of fine powders in the carrier increases, a magnetization per particle thus decreases, and the carrier scatters can be effectively prevented. On the other hand, when the volume average particle diameter is 150 μm or less, an undesired phenomenon can be effectively prevented in which a specific surface area decreases, which may cause the toner to scatter, and in a case of a full color having many solid areas, a poor reproduction occurs, in particular, in the solid areas.

### (Resin Layer)

The resin layer may contain a resin and, as appropriate, other components. The resin used in the resin layer may be any well-known material imparting a preferred chargeability. Specifically, it is preferable to use a silicone resin, an acrylic resin, or a combination of these. A composition for forming the resin layer preferably contains a silane coupling agent.

An average thickness of the resin layer is preferably 0.05 μm to 0.50 μm.

### (Measurement Method)

### <Volume Average Particle Diameter of Resin Particle>

The volume average particle diameter (Dv) of the resin particle was measured using a Coulter® Multisizer III (aperture diameter 100 μm, manufactured by Beckman Coulter, Inc.) and analysis software, Beckman Coulter® Multisizer 3 (version 3.51, manufactured by Beckman Coulter, Inc.).

10 mg of the measurement sample was added to 5 mL of a 10%-by-mass surfactant (alkylbenzene sulfonate, NEOGEN® SC-A, manufactured by Dai-ichi Kogyo Seiyaku Co., Ltd.), and the mixture was dispersed for one minute using an ultrasonic disperser. Thereafter, any amount of 25 mL of an electrolyte, Isoton® III (manufactured by Beckman Coulter, Inc.), was added, and the mixture was dispersed for one minute using an ultrasonic disperser to prepare a sample dispersion.

Next, 100 mL of the electrolyte and an appropriate amount of the sample dispersion were added to a beaker, and 30,000 particles were measured at a concentration at which the particle diameters of 30,000 particles could be measured in 20 seconds, and the volume average particle diameter (Dv) was calculated from the particle diameter distribution.

### <Average Circularity of Resin Particle>

An average circularity of the resin particle was measured using a flow type particle image analyzer FPIA®-3000 (manufactured by SYSMEX Co., Ltd.). A 1%-NaCl aqueous solution was prepared using first-grade sodium chloride (manufactured by Fuji Film Wako Pure Chemical Industries, Ltd.), and then 50 ml to 100 ml of the solution was passed through a 0.45 μm filter. 0.1 ml to 5 ml of alkylbenzene sulfonate (Neogen®, manufactured by Dai-ichi Kogyo Seiyaku Co., Ltd.) was added as a dispersant, and 1 mg to 10 mg of the sample was added.

This was subjected to dispersion treatment for one minute using an ultrasonic disperser, and the particle concentration was adjusted to 5,000 particles/μl to 15,000 particles/μl, and the average circularity was measured using this dispersion.

### <Loose Apparent Density of Resin Particle>

A loose apparent density of the resin particle was determined by putting 10 g of the toner into a 50 cm³ stoppered measuring cylinder, shaking it up and down vigorously 10 times, leaving it for ten minutes, reading the scale, and calculating using the following formula.

$$Loose apparent density ( g / {cm}^{3} ) = \frac{\begin{matrix}( Mass of sample + Mass of stoppered measuring \\ cylinder ) - ( Mass of stoppered measuring cylinder )\end{matrix}}{Volume of particles}$$

### <Adhesive Strength of Resin Particle>

An adhesive strength of the resin particle was measured using an AGGROBOT® manufactured by Hosokawa Micron Corporation.

A measurement procedure is as follows.

After storing the toner for 24 hours in an environment of 32° C./54% (with the lid open), 5 g of the toner was filled into a two-divisible cell with a diameter of 25 mm for the AGGROBOT®, and after compression, the tensile breaking stress Ft [gf] was measured, which was taken as the adhesive strength [gf] of the resin particle.

### Measurement Conditions are as Follows:

Compression conditions: 0.1 mm/sec, maximum compression force 32 kgf, holding time after compression 60 sec

Tensile conditions: spring linearity 1 mm, tensile speed 0.6 mm/sec, tensile data sampling start time 0 sec, tensile data sampling time 20 s

Additional conditions: Cell temperature 32° C.

### <Specific Surface Area BET>

The specific surface area of the resin particle was calculated by the BET method based on the amount of nitrogen adsorption. In the present disclosure, the surface area was measured using a Macsorb® HM model-1208 (manufactured by Mountec Co., Ltd.).

### <Glass Transition Temperature (Tg)>

The glass transition temperature (Tg) of the binder resin can be measured, for example, by using a DSC system (differential scanning calorimeter) (“Q-200”, manufactured by TA Instruments). Specifically, the glass transition temperature of a sample to be measured can be measured according to the following procedure. First, about 5.0 mg of a sample to be measured is charged into a sample container made of aluminum, and the sample container is placed on a holder unit and set in an electric furnace. Next, in a nitrogen atmosphere, the sample is heated from −80° C. to 150° C. at a heating rate of 10° C./min (first temperature increase). Afterwards, the sample is cooled from 150° C. to −80° C. at a cooling rate of 10° C./min, and then, heated again to 150° C. at a heating rate of 10° C./min (second temperature increase). During each of the first temperature increase and the second temperature increase, a DSC curve is measured by using a differential scanning calorimeter (“Q-200”, manufactured by TA Instruments). From the obtained DSC curves, the DSC curve at the first temperature increase can be selected by using an analysis program in the Q-200 system, to determine the glass transition temperature (Tg) of the sample to be measured at the first temperature increase. Similarly, the DSC curve at the second temperature increase can be selected to determine the glass transition temperature (Tg) of the sample to be measured at the second temperature increase.

Regarding the glass transition temperature (Tg) of the binder resin, unless otherwise specified, the glass transition temperature (Tg) at the second temperature increase is used as the glass transition temperature Tg (° C.).

### [Measurement of Molecular Weight]

A molecular weight of each component of the binder resin can be measured, for example, by the following method.
Gel permeation chromatography (GPC) measurement device: GPC-8220GPC (manufactured by Tosoh Corporation)
Column: TSKgel Super® HZM-H 15 cm triple column (manufactured by Tosoh Corporation)
Temperature: 40° C.
Solvent: THF
Flow rate: 0.35 mL/min
Sample: 100 μL of 0.15 mass % sample injected
Pretreatment of sample: Resin particles are dissolved in tetrahydrofuran THF (containing a stabilizer, manufactured by Wako Pure Chemicals, Ltd.) at 0.15 mass %, and then, filtered through a 0.2 μm filter, to use the filtrate as a sample. 100 μL of the THF sample solution is injected and measured.

In measuring the molecular weight of the sample, the molecular weight distribution of the sample is calculated from the relationship between the count number and the logarithmic value of a calibration curve prepared by using several types of monodispersed polystyrene standard samples. Std. No. S-7300, S-210, S-390, S-875, S-1980, S-10.9, S-629, S-3.0, and S-0.580 of SHODEX STANDARD manufactured by Showa Denko K.K. are used as polystyrene standard samples for preparing the calibration curve. A refractive index (RI) detector is used as the detector.

### (Image Forming Apparatus)

Next, a method for forming an image by the image forming apparatus according to one embodiment of the present disclosure will be described with reference to the drawing. Although a printer is illustrated as an example of the image forming apparatus in the present embodiment, the image forming apparatus is not particularly limited as long as the apparatus may form an image using a toner, such as a copier, a facsimile, and a multifunction machine.

The image forming apparatus includes a paper feed unit 210, a conveying unit 220, an image creating unit 230, a transfer unit 240, and a fixing unit 250.

The paper feed unit 210 includes a paper feed cassette 211 in which a paper sheet P to be fed is stacked, and a paper feed roller 212 that feeds the paper sheet P stacked in the paper feed cassette 211 one sheet by one sheet at a time.

The conveying unit 220 includes a roller 221 that conveys the paper sheet P fed by the paper feed roller 212 toward the transfer unit 240, a pair of timing rollers 222 that hold a distal end of the paper sheet P conveyed by the roller 221 and waits to send the paper sheet P to the transfer unit 240 at a predetermined timing, and a paper discharge roller 223 that discharges the paper sheet P with a color toner image fixed thereto onto a paper discharge tray 224.

The image creating unit 230 includes, spaced at a predetermined interval from left to right in the drawing, an image forming unit 180Y that forms an image using a developer including a yellow toner, an image forming unit 180C that uses a developer including a cyan toner, an image forming unit 180M that uses a developer including a magenta toner, an image forming unit 180K that uses a developer including a black toner, and an exposure unit 233.

The Image forming units 180Y, 180C, 180M, 180K are arranged to be rotatable clockwise in the drawing, and respectively include photoconductor drums 231Y, 231C, 231M, 231K on each of which an electrostatic latent image and a toner image are formed, chargers 232Y, 232C, 232M, 232K that uniformly charge a surface of the respective photoconductor drums 231Y, 231C, 231M, 231K, and cleaners 236Y, 236C, 236M, 236K that removes a toner remaining on the surface of the respective photoconductor drums 231Y, 231C, 231M, 231K.

Here, each photoconductor drum is not particularly limited in structure, size, and the like, and can be appropriately selected from well-known photoconductor drums. A material of each photoconductor drum is not particularly limited and can be appropriately selected for any purpose. Examples of the material include, but are not limited to, an inorganic photoconductor such as amorphous silicon and selenium, and an organic photoconductors (OPC) such as polysilane and phthalopolymethine. Examples of the organic photoconductor include, but are not limited to, a multi-layer photoconductor and a single-layer photoconductor. The multi-layer photoconductor has a laminated structure in which, on a support body such as an aluminum drum, a layer in which a charge generation material such as metal-free phthalocyanine or titanyl phthalocyanine is dispersed in a binder resin (charge generation layer), and a layer in which a charge transport material is dispersed in a binder resin (charge transport layer) are laminated. The single-layer photoconductor includes a photosensitive layer having a single layer structure in which both a charge generation material and a charge transport material are dispersed in a binder resin on a support body.

In a case of the single-layer photoconductor, a hole transport agent and an electron transport agent may be added to the photosensitive layer as charge transport materials.

Further, an undercoat layer may be provided between the support body and the charge generation layer in the laminated photoconductor or between the support body and the photosensitive layer in the single-layer photoconductor.

The image forming units 180Y, 180C, 180M, 180Kinclude toner bottles 234Y, 234C, 234M, 234K that house a toner of each color, and sub-hoppers 160Y, 160C, 160M, 160K that replenish the toner supplied from the toner bottles 234Y, 234C, 234M, 234K, respectively. It is noted that any one of the image forming units 180Y, 180C, 180M, 180K is simply called the image forming unit.

The exposure unit 233 irradiates the photoconductor drums 231Y, 231C, 231M, 231K with laser light L emitted from a light source 233a, based on image information by reflecting the light on polygon mirrors 233bY, 233bC, 233bM, 233bKrotated and driven by a motor.

The developer includes a toner and a carrier. The four image forming units 180Y, 180C, 180M, 180K have substantially the same mechanical configuration, except that the developers used are different.

The transfer unit 240 includes a drive roller 241, a driven roller 242, an intermediate transfer belt 243 rotatable counterclockwise in the drawing as the drive roller 241 drives, primary transfer rollers 244Y, 244C, 244M, 244K arranged opposite the respective photoconductor drums 231Y, 231C, 231M, 231K across the intermediate transfer belt 243, and a secondary opposing roller 245 and a secondary transfer roller 246 arranged opposite each other across the intermediate transfer belt 243 at a transfer position of a toner image to a paper sheet.

It is noted that in the present embodiment, an elastic intermediate transfer belt may be used as the intermediate transfer belt 243. As the elastic intermediate transfer belt, for example, an elastic intermediate transfer belt obtained by laminating a flexible elastic layer on a rigid base layer that provides a relatively flexible property may be used.

To prevent the intermediate transfer belt 243 from meandering, a guide member that prevents deviation may be provided on an inner peripheral surface of the intermediate transfer belt 243.

The fixing unit 250 includes a fixing belt 251 including an internal heater for heating the paper sheet P, and a pressure roller 252 that rotatably applies a pressure to the fixing belt 251 to form a nip. As a result, a heat and a pressure are applied to the color toner image on the paper sheet P, and the color toner image is fixed. The paper sheet P on which the color toner image is fixed is discharged onto the paper discharge tray 224 by the paper discharge roller 223, and thus, a series of image forming processes is completed.

### EXAMPLES

The present disclosure will be specifically described below with reference to Production Examples, Synthesis Examples, Preparation Examples, Examples, and Comparative Examples; however, the present disclosure is not limited to such Production Examples, Synthesis Examples, Preparation Examples, and Examples. In the Production Examples, Synthesis Examples, Preparation Examples, Examples, and Comparative Examples, unless otherwise indicated, “%” denotes “% by mass”, and “part” denotes “part by mass”. Blending amounts in the Examples and Comparative Examples indicate blending amounts of solid content in each raw material.

### <Preparation of Amorphous Polyester Resins for Core A-1 to A-4>

Into a reaction tank equipped with a cooling pipe, a stirrer, and a nitrogen inlet pipe, the raw materials presented in Table 1 were charged so that the molar ratio of hydroxyl groups to carboxylic acid (OH/COOH) was 1.2, and 1,000 ppm of tetrabutoxy titanate was further charged as a condensation catalyst relative to the total amount of monomers. The temperature was raised to 200° C. under a nitrogen stream over two hours, and then to 230° C. over three hours, and the mixture was reacted for five hours while distilling off the water produced. Thereafter, the mixture was reacted for three hours under reduced pressure of 5 mmHg to 15 mmHg and cooled to 200° C. Thereafter, trimellitic anhydride was added in the amount presented in Table 1 and reacted at normal pressure at 200° C. for one hour, and then further reacted under reduced pressure of 5 mmHg to 20 mmHg until the desired molecular weight was reached, to obtain an [amorphous polyester resin for core A-1] to an [amorphous polyester resin for core A-4].

### <Preparation of Amorphous Polyester Resins For Shell B-1 to B-4>

Into a reaction tank equipped with a cooling pipe, a stirrer, and a nitrogen inlet pipe, the raw materials presented in Table 1 were charged so that the molar ratio of hydroxyl groups to carboxylic acid (OH/COOH) was 1.2, and 1,000 ppm of tetrabutoxy titanate was further charged as a condensation catalyst relative to the total amount of monomers. The temperature was raised to 200° C. under a nitrogen stream over two hours, and then to 230° C. over three hours, and the mixture was reacted for five hours while distilling off the water produced. Thereafter, the mixture was reacted for three hours under reduced pressure of 5 mmHg to 15 mmHg and cooled to 200° C. Thereafter, trimellitic anhydride was added in the amount presented in Table 1 and reacted at normal pressure at 200° C. for one hour, and then further reacted under reduced pressure of 5 mmHg to 20 mmHg until the desired molecular weight was reached, to obtain an [amorphous polyester resin for shell B-1] to an [amorphous polyester resin for shell B-4].

### <Preparation of Amorphous Polyester Resin Solutions For Shell B-1 to B-4>

200 parts of the [amorphous polyester resin for shell B-1] and 200 parts of methyl ethyl ketone were placed in a container and mixed for 60 minutes at 5,000 rpm with a TK HOMOMIXER (manufactured by Primix Corporation) to obtain an [amorphous polyester resin solution for shell B-1].

An [amorphous polyester resin for shell B-2] to an [amorphous polyester resin for shell B-4] were also prepared in much the same manner as the [amorphous polyester resin solution for shell B-1] to obtain the [amorphous polyester resin solution for shell B-2] to the [amorphous polyester resin solution for shell B-4].

### <Preparation of Shell Aqueous Phase 1>

468 parts of water and 132 parts of methyl ethyl ketone were mixed and stirred to obtain a white transparent liquid. Such liquid was designated as [shell aqueous phase 1].

### <Preparation of Amorphous Polyester Resin Dispersions For Shell B-1 to B-4>

While stirring 400 parts of the solution of [amorphous polyester resin solution for shell B-1] with a TK HOMOMIXER (manufactured by Primix Corporation) at a rotation speed of 8,000 rpm, 28% ammonia water was charged in an amount equivalent to a neutralization rate of 100% relative to the acid value of [amorphous polyester resin solution for shell B-1] and mixed for ten minutes, and then 600 parts of [shell aqueous phase 1] was gradually added dropwise to invert a phase of the [amorphous polyester resin solution for shell B-1] and emulsify the resultant [amorphous polyester resin solution for shell B-1]. The solvent of the resultant [amorphous polyester resin solution for shell B-1] was removed by an evaporator to obtain a [polyester resin dispersion for shell B-1]. A solid content of the [amorphous polyester resin dispersion for shell B-1] was adjusted to 25%.

The [amorphous polyester resin solution for shell B-2] to the [amorphous polyester resin solution for shell B-4] were also subjected to the same treatment as that performed on the [amorphous polyester resin solution for shell B-1] to obtain an [amorphous polyester resin dispersion for shell B-2] to an [amorphous polyester resin dispersion for shell B-4]. The solid content of the [amorphous polyester resin dispersion for shell B-2] to the [amorphous polyester resin dispersion for shell B-4] was adjusted to 25%.

### <Synthesis of Crystalline Polyester Resin C-1>

In a reaction vessel equipped with a cooling tube, a stirrer, a dehydration tube, a thermocouple, and a nitrogen inlet tube, 1,12-dodecanedioic acid and 1,6-hexanediol were charged so that the molar ratio of hydroxyl groups to carboxyl groups, OH/COOH, was 1.2, and trimellitic anhydride was added in a molar ratio of 0.047. The mixture was reacted together with titanium tetraisopropoxide (500 ppm relative to the resin component) at 180° C. for 10 hours, then heated to 200° C. and reacted for three hours, and further reacted at a pressure of 8.3 kPa for two hours to obtain a [crystalline polyester resin C-1].

### <Preparation of Crystalline Polyester Resin Dispersion C-1>

A container equipped with a stirring rod and a thermometer was charged with 45 parts of the [crystalline polyester resin C-1] and 450 parts of ethyl acetate, and the temperature was raised to 80° C. while stirring. The mixture was then maintained at 80° C. for five hours, and then cooled to 30° C. in one hour. The mixture was then dispersed using a bead mill (Ultraviscomill™, manufactured by Imex Co., Ltd.) under conditions of a liquid feed rate of 1 kg/hour, a disk peripheral speed of 6 m/second, filled by 80% by volume of zirconia beads with a diameter of 0.5 mm, and 3 passes to obtain a [crystalline polyester resin dispersion C-1] having a median diameter of 550 nm. The solid content of the resulting crystalline polyester resin dispersion was adjusted to 20%.

### <Preparation of Wax Dispersion W-1>

A container equipped with a stirring rod and a thermometer was charged with 300 parts of ester wax (WE-11, manufactured by NOF Corporation, a synthetic wax made from plant-derived monomers, melting point 67° C.) and 1,200 parts of ethyl acetate, and the temperature was raised to 80° C. while stirring. The mixture was then maintained at 80° C. for five hours and then cooled to 30° C. The mixture was then dispersed using a bead mill (Ultraviscomill™, manufactured by Imex) under conditions of a liquid feed rate of 1 kg/hr, a disk peripheral speed of 6 m/sec, filled by 80% by volume of zirconia beads with a diameter of 0.5 mm, and 3 passes to obtain a [wax dispersion W-1] with a median diameter of 500 nm. The solids concentration of the resulting wax dispersion was adjusted to 20%.

### <<Measurement of Median Diameter of Crystalline Polyester Resin Dispersion and Wax Dispersion>>

The median diameters of the [crystalline polyester resin dispersion C-1] and the [wax dispersion W-1] were measured under the following measurement conditions by putting the [crystalline polyester resin dispersion C-1] or the [wax dispersion W-1] in a dispersion state into a laser diffraction/scattering type particle diameter distribution measurement device (LA-920, manufactured by Horiba, Ltd.).

### [Measurement Conditions]

Solvent: Ethyl acetate
Measurement cell: Batch type cell 10 mL
Circulation: Ultrasonic probe 30 W, 22.5 kHz
Measurement sample volume: Transmittance 75% to 90%
Measurement time: 20 seconds

### <Preparation of Masterbatch MB-1>

1,200 parts of water, 500 parts of carbon black (PRINTEX® 35, manufactured by Degussa AG) [DBP oil absorption amount=42 mL/100 mg, pH=9.5], and 500 parts of the [amorphous polyester resin A-2] were added to and mixed in a Henschel mixer (manufactured by Nippon Coke & Engineering Co., Ltd.). The obtained mixture was kneaded by using two rolls at 150° C. for 30 minutes, and then, rolled to cool, and pulverized in a pulverizer to obtain a [master batch MB-1].

### Example 1

### <Preparation of Oil Phase>

570 parts of the [amorphous polyester resin for core A-1], 200 parts of the [master batch MB-1], 50 parts of the [crystalline polyester resin C-1], and 80 parts of the [wax dispersion W-1] were placed in a container, and the solid content was adjusted to 50% with ethyl acetate. The mixture was mixed for 60 minutes at 5,000 rpm with a TK HOMOMIXER (manufactured by Primix Corporation) to obtain an [oil phase 1].

It is noted that the above blend amounts indicate the blend amounts of solid content in each raw material.

### <Preparation of Aqueous Phase>

990 parts of water, 20 parts of sodium dodecyl sulfate, and 90 parts of ethyl acetate were mixed and stirred to obtain a milky white liquid. The obtained liquid was defined as an [aqueous phase 1].

### <Emulsification Process>

While 900 parts of the [oil phase 1] was stirred with a TK HOMOMIXER at a rotation speed of 8,000 rpm, 20 parts of 28% aqueous ammonia was added, and the mixture was mixed for ten minutes. Thereafter, 1,200 parts of the [aqueous phase 1] was gradually added dropwise to the mixture, and the phase of the resultant mixture was inverted and emulsified to obtain an [emulsified slurry 1].

### <Solvent Removal Process>

The [emulsified slurry 1] was placed in a container equipped with a stirrer and a thermometer, and the solvent was removed at 30° C. for 180 minutes to obtain a [slurry with removed solvent 1]. The solid content was adjusted to 25% with ion-exchanged water.

### <Aggregating Process>

100 parts of the [slurry with removed solvent 1] and ion-exchanged water were placed in a container and mixed, and 6 parts of a 20% aqueous magnesium sulfate solution was added dropwise and stirred for an additional five minutes. The mixture was then heated to 55° C. and aggregated until the volume average particle diameter became approximately 5.0 μm.

### <Shell Forming Process>

When the particle diameter of the cores reached 5.0 μm in the aggregating, 9.3 parts of [amorphous polyester resin dispersion for shell B-1] was added, and 10 parts of a 20% aqueous magnesium sulfate solution was further added dropwise and stirred for another ten minutes, after which the temperature was raised to 65° C. and the mixture was stirred for 30 minutes.

### <Fusing and Stopping Processes>

25 parts of sodium sulfate was added, and an [aggregated slurry 1] was heated to 68° C. with stirring, and cooled when a desired average circularity was reached to obtain a [dispersed slurry 1].

### <Annealing, Cleaning, and Drying Processes>

The [dispersed slurry 1] was stored at 45° C. for 10 hours, filtered under a reduced pressure, and washed and dried as follows.

(1): 100 parts of ion-exchanged water was added to the filter cake, the mixture was mixed by using a TK HOMOMIXER (at a rotation speed of 12,000 rpm for ten minutes) and, thereafter, the mixture was filtered.

(2) 100 parts of a 10% aqueous solution of sodium hydroxide were added to the filter cake of (1) and mixed using a TK HOMOMIXER (at a rotation speed of 12,000 rpm for 30 minutes), followed by filtration under reduced pressures.

(3): 100 parts of 10% hydrochloric acid was added to the filter cake obtained in (2), and the mixture was mixed by using a TK HOMOMIXER (at a rotation speed of 12,000 rpm for ten minutes) and then, the mixture was filtered.

(4) 300 parts of ion-exchanged water was added to the filter cake obtained in (3), mixed with a TK HOMOMIXER (at a rotation speed of 12,000 rpm for ten minutes), and then filtered. The above operations (1) to (4) were repeated twice to obtain a [filter cake 1].

The [filter cake 1] was dried in a circulating air dryer at 45° C. for 48 hours and sieved through a sieve having 75 μm-mesh openings to obtain a [resin particle base body 1].

### <External Additive Treatment Process>

2.0 parts of hydrophobic silica (HDK-2000, manufactured by Clariant AG), serving as an external additive, was mixed to 100 parts of the [resin particle base body 1] in a Henschel mixer, and the mixture was passed through a sieve having 500 mesh openings to obtain [resin particles 1].

### Examples 2 to 5, 8 to 14, Comparative Examples 1, 2, and 6

[Resin particles 2] to [resin particles 5], [resin particles 8] to [resin particles 14] of the Examples and [resin particles 15], [resin particles 16], and [resin particles 20] of the Comparative Examples were obtained in much the same manner as in Example 1, except that the [amorphous polyester resin for core] and the [amorphous polyester resin for shell] were as presented in Table 2.

### Example 6

[Resin particles 6] were obtained in much the same manner as in Example 1, except that the [amorphous polyester resin for core] was changed to that presented in Table 2 and the amount of 20% aqueous magnesium sulfate solution added in the aggregating was changed to 5 parts.

### Example 7

[Resin particles 7] were obtained in much the same manner as in Example 1, except that the [amorphous polyester resin for core] was changed to that presented in Table 2 and the amount of 20% aqueous magnesium sulfate solution added in the aggregating was changed to 7 parts.

### Comparative Example 3

[Resin particles 17] were obtained in much the same manner as in Example 1, except that the temperature in the fusing was changed to 70° C.

### Comparative Example 4

[Resin particles 18] were obtained in much the same manner as in Example 1, except that in Example 1, the [amorphous polyester resin for core] was changed to that presented in Table 2, the amount of 20% magnesium sulfate aqueous solution added in the aggregating was changed to 5 parts, and the temperature in the fusing was changed to 70° C.

### Comparative Example 5

[Resin particles 19] were obtained in much the same manner as in Example 1, except that the acid monomers and alcohol monomers in Example 1 were changed to those presented in Tables 1 and 2, the [amorphous polyester resin for core] and [amorphous polyester resin for shell] in the aggregating were changed to those presented in Table 2, the amount of 20% aqueous magnesium sulfate solution added in the aggregating was changed to 7 parts, and the temperature in the fusing was changed to 70° C.

### Comparative Examples 7 and 8

[Resin particles 21] and [Resin particles 22] were obtained in much the same manner as in Example 1, except that the [amorphous polyester resin for core] and the [amorphous polyester resin for shell] were changed to those presented in Table 2 and the amount of the [amorphous polyester resin dispersion for shell] in the forming into a shell was changed to 4.6 parts.

### Comparative Examples 9 and 10

[Resin particles 23] and [resin particles 24] were obtained in much the same manner as in Example 1, except that the [amorphous polyester resin for core] was changed to that presented in Table 2 and the target particle diameters in the aggregating and the forming into a shell were 4.4 μm and 6.2 μm, respectively.

The physical properties of the [resin particle 1] to the [resin particle 24] obtained above are presented in Table 3, and the results of the image evaluation and the cleanability evaluation are presented in Table 4.

TABLE 1

| | | | Amorphous polyester resin for core | | | | Amorphous polyester resin for shell | | | |
|---|---|---|---|---|---|---|---|---|---|---|
| | | | A-1 | A-2 | A-3 | A-4 | B-1 | B-2 | B-3 | B-4 |
| Raw | Acid | Adipic acid | 10.2 | 10.3 | 8.5 | 10.3 | 10.2 | 10.3 | 8.4 | 8.3 |
| material A | | Isophthalic acid | | | | | 56.0 | 56.4 | 46.2 | 42.5 |
| | | Terephthalic acid | 62.2 | 62.5 | 51.6 | 62.6 | | | | |
| | | Succinic acid | | | | | 4.4 | 4.5 | 3.7 | 3.6 |
| | Acid content | Sulfoisophthalic acid | | | | | | | | 5.1 |
| | containing | sodium salt | | | | | | | | |
| | sulfonate | | | | | | | | | |
| | group | | | | | | | | | |
| | Alcohol | Ethylene oxide 2 moles | 63.7 | 62.5 | 51.6 | 62.6 | 31.1 | 31.3 | 25.7 | 25.4 |
| | | adduct of bisphenol A | | | | | | | | |
| | | Propylene oxide 2 moles | 44.4 | 44.7 | 36.8 | 44.7 | 78.3 | 77.1 | 64.6 | 63.9 |
| | | adduct of bisphenol A | | | | | | | | |
| | | 1,2-Propanediol | 15.0 | 15.1 | 12.5 | 15.1 | 15.0 | 15.1 | 12.4 | 12.3 |
| | | Trimethylolpropane | 0.4 | 0.9 | 0.7 | | 0.9 | | 0.7 | 0.7 |
| | | 1,2,4-Butanetriol | | | | 0.7 | | 1.3 | | |

| | | | |
|---|---|---|---|
| Polyethylene terephthalate (PET) | 35 | 35 | 35 |

| Trimellitic anhydride | | 4.0 | 4.0 | 3.3 | 4.0 | 4.0 | 4.0 | 3.3 | 3.3 |
|---|---|---|---|---|---|---|---|---|---|
| Resin property | Tg (g) | 51.1 | 52.4 | 53.3 | 54.6 | 56.9 | 58.7 | 57.5 | 57.8 |
| | Mw (—) | 11,000 | 12,000 | 12,000 | 14,000 | 14,000 | 16,000 | 13,000 | 14,000 |

*Units of values in Table are “parts by mass” unless otherwise noted.

TABLE 2

| | | Material type | | | | |
|---|---|---|---|---|---|---|
| | | | | Amorphous | Processing | |
| | | | | polyester | Aggregating | Heating |
| | | Amorphous | Amorphous | resin for shell | agent in | temperature |
| | | polyester resin | polyester resin | dispersion | aggregating | in fusing |
| | | for core | for shell | (Part) | (Part) | ° C. |
| Resin particles 1 | Ex. 1 | A-1 | B-1 | 9.3 | 6 | 68 |
| Resin particles 2 | Ex. 2 | A-1 | B-2 | 9.3 | 6 | 68 |
| Resin particles 3 | Ex. 3 | A-1 | B-1 | 9.3 | 6 | 68 |
| Resin particles 4 | Ex. 4 | A-2 | B-1 | 9.3 | 6 | 68 |
| Resin particles 5 | Ex. 5 | A-2 | B-1 | 9.3 | 6 | 68 |
| Resin particles 6 | Ex. 6 | A-2 | B-1 | 9.3 | 5 | 68 |
| Resin particles 7 | Ex. 7 | A-2 | B-1 | 9.3 | 7 | 68 |
| Resin particles 8 | Ex. 8 | A-3 | B-1 | 9.3 | 6 | 68 |
| Resin particles 9 | Ex. 9 | A-3 | B-1 | 9.3 | 6 | 68 |
| Resin particles 10 | Ex. 10 | A-3 | B-2 | 9.3 | 6 | 68 |
| Resin particles 11 | Ex. 11 | A-3 | B-3 | 9.3 | 6 | 68 |
| Resin particles 12 | Ex. 12 | A-3 | B-4 | 9.3 | 6 | 68 |
| Resin particles 13 | Ex. 13 | A-3 | B-3 | 9.3 | 6 | 68 |
| Resin particles 14 | Ex. 14 | A-3 | B-4 | 9.3 | 6 | 68 |
| Resin particles 15 | Com. Ex. 1 | A-4 | B-1 | 9.3 | 6 | 68 |
| Resin particles 16 | Com. Ex. 2 | A-4 | B-4 | 9.3 | 6 | 68 |
| Resin particles 17 | Com. Ex. 3 | A-1 | B-1 | 9.3 | 6 | 70 |
| Resin particles 18 | Com. Ex. 4 | A-2 | B-1 | 9.3 | 5 | 70 |
| Resin particles 19 | Com. Ex. 5 | A-2 | B-2 | 9.3 | 7 | 70 |
| Resin particles 20 | Com. Ex. 6 | A-2 | B-2 | 9.3 | 6 | 68 |
| Resin particles 21 | Com. Ex. 7 | A-3 | B-1 | 4.6 | 6 | 68 |
| Resin particles 22 | Com. Ex. 8 | A-3 | B-2 | 4.6 | 6 | 68 |
| Resin particles 23 | Com. Ex. 9 | A-2 | B-1 | 9.3 | 6 | 68 |
| Resin particles 24 | Com. Ex. 10 | A-2 | B-1 | 9.3 | 6 | 68 |

TABLE 3

| | | Volume | | | | |
|---|---|---|---|---|---|---|
| | | average | | | Loose | |
| | | particle | | | apparent | Adhesive |
| | | diameter | Circularity (X) | BET | density (Y) | strength |
| | | (μm) | — | (m²/g) | (g/cm³) | (gf) |
| Resin particles 1 | Ex. 1 | 5.2 | 0.940 | 0.9 | 0.43 | 92 |
| Resin particles 2 | Ex. 2 | 5.1 | 0.941 | 1.3 | 0.40 | 125 |
| Resin particles 3 | Ex. 3 | 5.0 | 0.980 | 0.9 | 0.49 | 146 |
| Resin particles 4 | Ex. 4 | 4.6 | 0.950 | 1.1 | 0.46 | 131 |
| Resin particles 5 | Ex. 5 | 4.8 | 0.968 | 0.9 | 0.41 | 138 |
| Resin particles 6 | Ex. 6 | 4.9 | 0.980 | 1.1 | 0.43 | 150 |
| Resin particles 7 | Ex. 7 | 5.3 | 0.930 | 1.1 | 0.41 | 85 |
| Resin particles 8 | Ex. 8 | 5.2 | 0.952 | 1.2 | 0.41 | 130 |
| Resin particles 9 | Ex. 9 | 5.1 | 0.972 | 1.0 | 0.46 | 145 |
| Resin particles 10 | Ex. 10 | 5.3 | 0.949 | 1.3 | 0.38 | 126 |
| Resin particles 11 | Ex. 11 | 5.4 | 0.950 | 1.2 | 0.42 | 134 |
| Resin particles 12 | Ex. 12 | 5.4 | 0.953 | 1.3 | 0.42 | 100 |
| Resin particles 13 | Ex. 13 | 5.5 | 0.971 | 1.1 | 0.45 | 120 |
| Resin particles 14 | Ex. 14 | 5.6 | 0.972 | 1.1 | 0.45 | 98 |
| Resin particles 15 | Com. Ex. 1 | 4.8 | 0.930 | 1.7 | 0.34 | 97 |
| Resin particles 16 | Com. Ex. 2 | 5.5 | 0.925 | 1.5 | 0.35 | 95 |
| Resin particles 17 | Com. Ex. 3 | 5.4 | 0.985 | 1.2 | 0.44 | 148 |
| Resin particles 18 | Com. Ex. 4 | 5.5 | 0.980 | 0.9 | 0.50 | 110 |
| Resin particles 19 | Com. Ex. 5 | 5.4 | 0.980 | 1.4 | 0.42 | 141 |
| Resin particles 20 | Com. Ex. 6 | 5.4 | 0.960 | 1.8 | 0.38 | 136 |
| Resin particles 21 | Com. Ex. 7 | 5.3 | 0.948 | 1.2 | 0.41 | 160 |
| Resin particles 22 | Com. Ex. 8 | 5.2 | 0.948 | 1.2 | 0.41 | 185 |
| Resin particles 23 | Com. Ex. 9 | 4.4 | 0.950 | 1.3 | 0.46 | 145 |
| Resin particles 24 | Com. Ex. 10 | 6.2 | 0.950 | 1.0 | 0.38 | 101 |

TABLE 4

| | | Fine line | | |
|---|---|---|---|---|
| | | repro- | Image | |
| | | ducibility | graininess | Cleanability |
| Resin particles 1 | Ex. 1 | Good | Good | Fair |
| Resin particles 2 | Ex. 2 | Fair | Good | Good |
| Resin particles 3 | Ex. 3 | Good | Fair | Good |
| Resin particles 4 | Ex. 4 | Good | Good | Fair |
| Resin particles 5 | Ex. 5 | Good | Good | Fair |
| Resin particles 6 | Ex. 6 | Good | Fair | Good |
| Resin particles 7 | Ex. 7 | Fair | Good | Good |
| Resin particles 8 | Ex. 8 | Fair | Good | Good |
| Resin particles 9 | Ex. 9 | Good | Fair | Good |
| Resin particles 10 | Ex. 10 | Fair | Good | Good |
| Resin particles 11 | Ex. 11 | Good | Good | Good |
| Resin particles 12 | Ex. 12 | Good | Excellent | Excellent |
| Resin particles 13 | Ex. 13 | Good | Good | Good |
| Resin particles 14 | Ex. 14 | Good | Excellent | Excellent |
| Resin particles 15 | Com. Ex. 1 | Fair | Good | Poor |
| Resin particles 16 | Com. Ex. 2 | Poor | Good | Fair |
| Resin particles 17 | Com. Ex. 3 | Good | Poor | Poor |
| Resin particles 18 | Com. Ex. 4 | Good | Poor | Poor |
| Resin particles 19 | Com. Ex. 5 | Good | Poor | Fair |
| Resin particles 20 | Com. Ex. 6 | Poor | Fair | Fair |
| Resin particles 21 | Com. Ex. 7 | Fair | Poor | Fair |
| Resin particles 22 | Com. Ex. 8 | Fair | Poor | Poor |
| Resin particles 23 | Com. Ex. 9 | Good | Poor | Fair |
| Resin particles 24 | Com. Ex. 10 | Poor | Good | Fair |

### (Evaluation Method)

A carrier used in an Imagio® MP C5503 (manufactured by Ricoh Co., Ltd.) and the resin particles obtained above were mixed so that the concentration of the resin particles was 7% by mass to obtain the developer.

### <Fine Line Reproducibility>

### [Fine Line Reproducibility]

The developer is placed in an Imagio® MP C5503 (manufactured by Ricoh Co., Ltd.), and a printing test of 6-point and 10-point characters is carried out in an environment of an air temperature of 30° C. and a relative humidity of 80%.

The reproducibility of the printed characters was evaluated on a three-level scale based on the following evaluation criteria.

### (Evaluation Criteria)

Good: 6-point characters are clear

Fair: Some of the 6-point characters are blurred

Poor: 10-point characters are partially blurred

### <Image Graininess>

The developer was placed in an Imagio® MP C5503 (manufactured by Ricoh Co., Ltd.), and 250 sheets of A4-sized originals with a 25% image area ratio were printed in monochrome continuously, and the uniformity of the halftone portions was evaluated.

### <Evaluation Rank>

Excellent: No problems at all

Good: No problem

Fair: Some problems but acceptable level

Poor: Problematic

### <Cleanability>

The developer was placed in an Imagio® MP C5503 (manufactured by Ricoh Co., Ltd.), and a vertical band pattern (relative to the paper travel direction) having 43 mm width and three charts were printed on 20 sheets of A4 size landscape. The resulting images were visually observed, and the cleanability was evaluated based on the presence or absence of image abnormalities due to poor cleaning.

### [Evaluation Criteria]

Excellent: Toner that has slipped through due to poor cleaning cannot be visually confirmed on the printed paper or on the photoconductor, and no streaks generated by the toner being slipped can be confirmed even when observing a part on the photoconductor in the longitudinal direction with a microscope.

Good: Toner that has slipped through due to poor cleaning cannot be visually confirmed on the printed paper or on the photoconductor.

Fair: Toner that has slipped through due to poor cleaning cannot be visually confirmed on the printed paper, but can be slightly confirmed on the photoconductor.

Poor: Toner that has slipped through due to poor cleaning can be visually confirmed on the printed paper and on the photoconductor.

For example, aspects of the present disclosure are as follows.

According to a first aspect, a resin particle includes a binder resin comprising a polyester resin, in which
the resin particle has a volume average particle diameter of 4.5 μm or more and 6.0 μm or less,
the resin particle has an adhesive strength of 150 gf or less, and
the resin particle satisfies the following relational expressions (1) to (3):

$$0.93 \leq X \leq 0 \text{.980} \qquad ( 1 )$$

$$Y < 0.5 \qquad ( 2 )$$

$$Y \geq 1. 5 X - 1.04 \qquad ( 3 )$$

where X represents a circularity of the resin particle and Y represents a loose apparent density (g/cm³) of the resin particle.

According to a second aspect, in the resin particle according to the first aspect, the loose apparent density Y of the resin particle satisfies the following relational expression (4).

$$0.4 \leq Y \leq 0.48 \qquad ( 4 )$$

According to a third aspect, in the resin particle according to the first aspect, the loose apparent density Y of the resin particle satisfies the following relational expression (5).

$$0.42 \leq Y \leq 0.45 \qquad ( 5 )$$

According to a fourth aspect, in the resin particle according to any one of the first aspect to the third aspect, the polyester resin includes a repeating unit derived from polyethylene terephthalate (PET) comprising a condensation product of terephthalic acid and ethylene glycol.

According to a fifth aspect, in the resin particle according to any one of the first aspect to the fourth aspect, the polyester resin includes a sulfonate group.

According to a sixth aspect, in the resin particle according to any one of the first aspect to the fifth aspect, the resin particle is granulated in an aqueous medium.

According to a seventh aspect, a toner includes the resin particle according to any one of the first aspect to the fifth aspect.

According to an eighth aspect, in the toner according to the seventh aspect, the resin particle is granulated in an aqueous medium.

According to a ninth aspect, an image forming apparatus includes:
an electrostatic latent image bearer,
an electrostatic latent image forming unit to form an electrostatic latent image on the electrostatic latent image bearer, and
a developing unit that containing the toner according to the seventh or eighth aspect to develop the electrostatic latent image formed on the electrostatic latent image bearer with the toner to form a toner image.

According to a tenth aspect, the image forming apparatus according to the ninth aspect further includes:
a transfer unit to transfer the toner image onto a recording medium, and
a fixing unit to fix the transferred toner image on the recording medium.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle comprising:
a binder resin comprising a polyester resin, wherein
the resin particle has a volume average particle diameter of 4.5 μm or more and 6.0 μm or less,
the resin particle has an adhesive strength of 150 gf or less, and
the resin particle satisfies the following relational expressions (1) to (3):
$$0.93 \leq X \leq 0.98 \qquad ( 1 )$$
$$Y < 0.5 \qquad ( 2 )$$
$$Y \geq 1. 5 X - 1.04 \qquad ( 3 )$$
where X represents a circularity of the resin particle and Y represents a loose apparent density (g/cm³) of the resin particle.

2. The resin particle according to claim 1, wherein the loose apparent density Y of the resin particle satisfies the following relational expression (4).
$$0.4 \leq Y \leq 0.48 . \qquad ( 4 )$$

3. The resin particle according to claim 1, wherein the loose apparent density Y of the resin particle satisfies the following relational expression (5).
$$0.42 \leq Y \leq 0.45 . \qquad ( 5 )$$

4. The resin particle according to claim 1, wherein the polyester resin includes a repeating unit derived from polyethylene terephthalate comprising a condensation product of terephthalic acid and ethylene glycol.

5. The resin particle according to claim 1, wherein the polyester resin includes a sulfonate group.

6. The resin particle according to claim 1, wherein the resin particle is granulated in an aqueous medium.

7. A toner comprising the resin particle according to claim 1.

8. The toner according to claim 7, wherein the resin particle is granulated in an aqueous medium.

9. An image forming apparatus, comprising:
an electrostatic latent image bearer;
an electrostatic latent image forming unit to form an electrostatic latent image on the electrostatic latent image bearer; and
a developing unit containing the toner according to claim 7 to develop the electrostatic latent image formed on the electrostatic latent image bearer with the toner to form a toner image.

10. The image forming apparatus according to claim 9, further comprising:
a transfer unit to transfer the toner image onto a recording medium; and
a fixing unit to fix the transferred toner image on the recording medium.
